(19) United States
(12) Patent Application Publication
(10) Pub. No.: US 2015/0015549 A1
(43) Pub. Date: Jan. 15, 2015

(54) TOUCH STYLUS AND OPERATING METHOD THEREOF

(71) Applicant: Raydium Semiconductor Corporation, Hsinchu (TW)

(72) Inventors: Ya-Ling Lu, Pingtung City (TW); Te-Chang Lin, Hsinchu City (TW); Kuo-Tsung Tseng, Zhubei City (TW); Chia-Hsiu Lin, Hsinchu City (TW); Yi-Ming Chen, Tainan City (TW); Wei-Yuan Cheng, Taichung City (TW)

(21) Appl. No.: 14/327,091

(22) Filed: Jul. 9, 2014

(30) Foreign Application Priority Data
Jul. 12, 2013 (TW) 102125066

(51) Int. Cl. G06F 3/01; G06F 3/0354

(52) U.S. Cl. CPC G06F 3/016; G06F 3/03545
USPC 345/179

(57) ABSTRACT

A touch stylus and operating method thereof are disclosed. The touch stylus includes a piezoelectric unit, a magnet unit, and a coil unit. The piezoelectric unit is formed by a piezoelectric material. The magnet unit is coupled to the piezoelectric unit. The coil unit is evenly wound on the outer of the magnet unit. When a tip of the touch stylus is forced and generates a vibration, the piezoelectric material of the piezoelectric unit is deformed by force to generate a piezoelectric current. When the touch stylus is shaken, the coil unit and the magnet unit will generate relative movement to change the distance between them and the magnetic flux will be changed, the coil unit will generate an induced current.

### BACKGROUND OF THE INVENTION

1. Field of the Invention

This invention relates to a touch input apparatus, especially to a touch stylus and an operating method thereof.

2. Description of the Related Art

In general, a conventional touch stylus can be a type of piezoelectric self-powered card. The conventional touch stylus may include a card body, a piezoelectric film, and an electronic apparatus. Wherein, the card body is flexible and elastic; the piezoelectric film is formed by a piezoelectric material and disposed in the card body. When the card body is deformed by force, the piezoelectric film will generate electronic energy, and the electronic apparatus will receive the electronic energy from the piezoelectric film and use the electronic energy as a driving power to drive the touch stylus.

However, the above-mentioned conventional touch stylus has following drawbacks of: (1) power supply is easily insufficient; (2) types of graphics tablet (digitizer) can be used are limited; (3) the user has to change battery; (4) high manufacturing cost.

Therefore, the invention provides a touch stylus and an operating method thereof to solve the above-mentioned problems occurred in the prior arts.

### SUMMARY OF THE INVENTION

An embodiment of the invention is a touch stylus. In this embodiment, the touch stylus includes a piezoelectric unit, a magnet unit, and a coil unit. The piezoelectric unit is formed by a piezoelectric material. The magnet unit is coupled to the piezoelectric unit. The coil unit is evenly wound on the outer of the magnet unit. When a tip of the touch stylus is forced and generates a vibration, the piezoelectric material of the piezoelectric unit is deformed by force to generate a piezoelectric current. When the touch stylus is shaken, the coil unit and the magnet unit will generate relative movement to change the distance between them and the magnetic flux will be changed, the coil unit will generate an induced current.

In an embodiment, the touch stylus further includes an energy storage unit. The energy storage unit is coupled to the piezoelectric unit and the coil unit and used for storing the extra piezoelectric current and induced current as reserve power.

In an embodiment, the touch stylus further includes a bonding substrate. The bonding substrate is disposed between the tip of the touch stylus and the piezoelectric unit and used for passing a pressure that the tip of the touch stylus is pressed to the piezoelectric unit.

In an embodiment, the touch stylus further includes a spring unit. The spring unit is coupled to the magnet unit and used for providing an elastic force and a buffering effect.

In an embodiment, the energy storage unit is an energy storage element.

Another embodiment of the invention is a method of operating a touch stylus. In this embodiment, the touch stylus includes a piezoelectric unit, a magnet unit, and a coil unit. The piezoelectric unit is formed by a piezoelectric material. The magnet unit is coupled to the piezoelectric unit. The coil unit is evenly wound on the magnet unit. The method includes steps of: (a) when a tip of the touch stylus is forced and generates a vibration, the piezoelectric material of the piezoelectric unit being deformed by force to generate a piezoelectric current; and (b) when the touch stylus is shaken, a distance between the coil unit and the magnet unit being changed due to a relative movement between the coil unit and the magnet unit and the coil unit generating an induced current due to a change of magnetic flux.

Compared to the prior art, the touch stylus and the touch stylus operating method of the invention have advantages of:

(1) power supply is sufficient;

(2) no limitations to the types of graphics tablet (digitizer) can be used;

(3) it is unnecessary for the user to change battery; and

(4) low manufacturing cost.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a functional block diagram of the touch stylus in an embodiment of the invention.

FIG. 2 illustrates an embodiment of the touch stylus in the invention.

FIG. 3 illustrates a flow chart of the touch stylus operating method in another embodiment of the invention.

### DETAILED DESCRIPTION

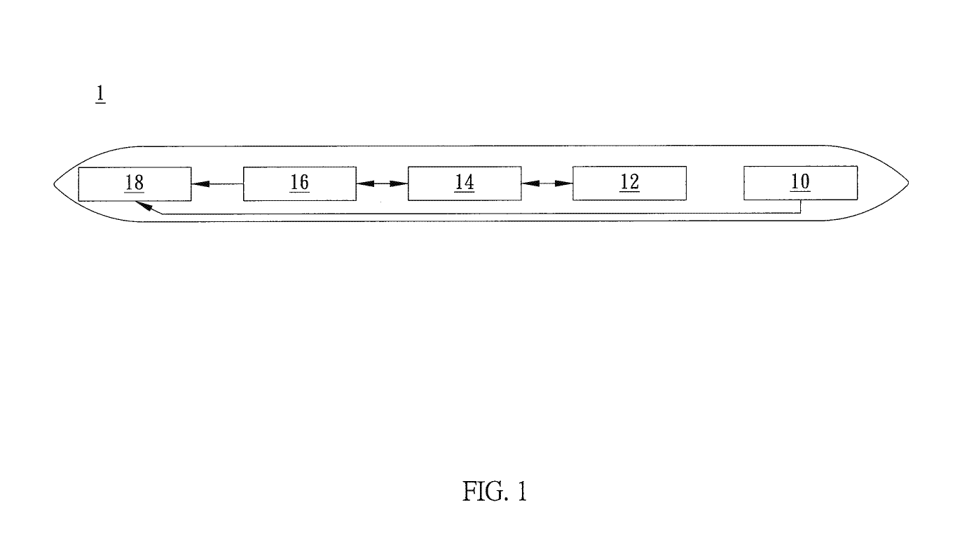

A preferred embodiment of the invention is touch stylus. In this embodiment, the touch stylus is used to perform a touch action on a touch panel of an electronic apparatus, but not limited to this. Please refer to FIG. 1. FIG. 1 illustrates a functional block diagram of the touch stylus in this embodiment.

As shown in FIG. 1, the touch stylus 1 includes a piezoelectric unit 10, a coil unit 12, a magnet unit 14, a spring unit 16, and an energy storage unit 18. Wherein, the piezoelectric unit 10 is coupled to the energy storage unit 18; the coil unit 12 is coupled to the magnet unit 14; the magnet unit 14 is coupled to the spring unit 16; the spring unit 16 is coupled to the energy storage unit 18.

When the touch stylus 1 moves up-and-down or left-and-right, the coil unit 12 and the magnet unit 14 will be moved relatively to change the distance between the coil unit 12 and the magnet unit 14, and the coil unit 12 will generate an induced current due to a change of magnetic flux.

The spring unit 16 is used for providing an elastic force and a buffering effect when the coil unit 12 moves. The energy storage unit 18 can be any kind of energy storage element and used for storing the extra piezoelectric current generated by the piezoelectric unit 10 as reserve power.

In this embodiment, the piezoelectric unit 10 is disposed in the touch stylus 1 and the piezoelectric unit 10 is formed by a piezoelectric material. When a tip of the touch stylus 1 touches a graphics tablet (digitizer), the tip of the touch stylus 1 will be vibrated by force and the piezoelectric material of the piezoelectric unit 10 will be deformed by force, so that an electrical field is changed and a current is generated.

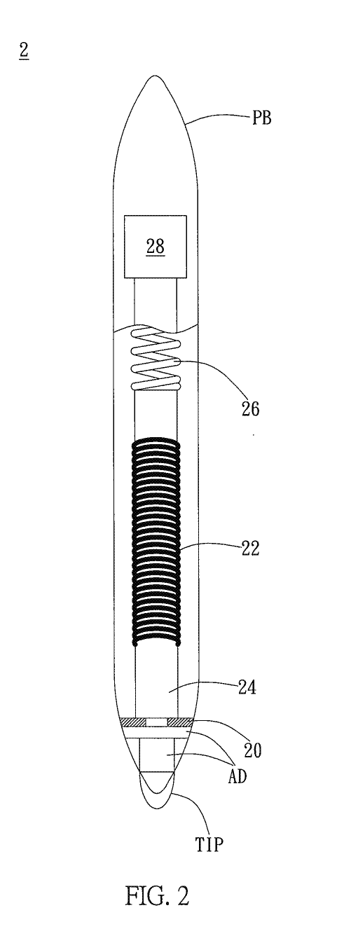

Then, Please refer to FIG. 2. FIG. 2 shows an embodiment of the touch stylus of the invention. As shown in FIG. 2, the touch stylus 2 includes a pen body PB, a pen tip TIP, a bonding substrate AD, a piezoelectric material 20, a coil 22, a magnet 24, a spring 26, and an energy storage element 28. Wherein, the bonding substrate AD, the piezoelectric material 20, the coil 22, the magnet 24, the spring 26, and the energy storage element 28 are all disposed in the pen body PB; the pen tip TIP is exposed out of the pen body PB; the bonding substrate AD is disposed between the pen tip TIP and the piezoelectric material 20; the piezoelectric material 20 is coupled to the magnet 24; the coil 22 is evenly wound on core periphery of the magnet 24; the spring 26 is coupled to the magnet 24; the energy storage element 28 is coupled to the spring 26.

In this embodiment, since the coil 22 is evenly wound on core periphery of the magnet 24, when the touch stylus 2 is shaken, the coil 22 and the magnet 24 disposed in the pen body PB will be moved relatively. That is to say, electrical power can be generated by electromagnetic induction between the coil 22 and the magnet 24 when the touch stylus 2 is shaken. In addition, since the bonding substrate AD is disposed between the pen tip TIP and the piezoelectric material 20, when the pen tip TIP touches the graphics tablet (digitizer) to write, the pen tip TIP will vibrate and the piezoelectric material 20 will be deformed by force, so that the electrical field will be changed to generate a current. In fact, the current generated by the piezoelectric material 20 can be used as a driving power supply. And, the energy storage element 28 can be used to store extra power as reserve power for the future.

Another embodiment of the invention is a method of operating a touch stylus. In this embodiment, the touch stylus includes a piezoelectric unit, a coil unit, a magnet unit, a spring unit, and an energy storage unit. Wherein, the piezoelectric unit is coupled to the energy storage unit; the coil unit is coupled to the magnet unit; the magnet unit is couple to the spring unit; the spring unit is coupled to the energy storage unit. The piezoelectric unit is formed by a piezoelectric material.

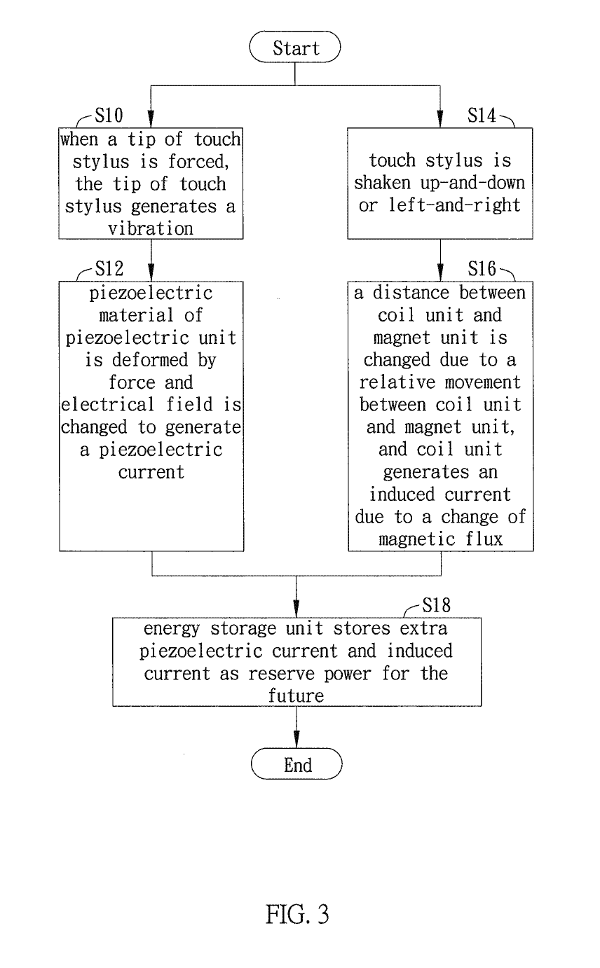

Please refer to FIG. 3. FIG. 3 illustrates a flow chart of the touch stylus operating method in this embodiment. As shown in FIG. 3, in the step S10, when a tip of the touch stylus is forced, the tip of the touch stylus generates a vibration. In the step S12, the piezoelectric material of the piezoelectric unit is deformed by force and the electrical field is changed to generate a piezoelectric current. In the step S14, the touch stylus is shaken up-and-down or left-and-right. In the step S16, a distance between the coil unit and the magnet unit is changed due to a relative movement between the coil unit and the magnet unit, and the coil unit generates an induced current due to a change of magnetic flux. In the step S18, the energy storage unit stores extra piezoelectric current and induced current as reserve power for the future.

Compared to the prior art, the touch stylus and the touch stylus operating method of the invention have advantages of:

(1) power supply is sufficient;

(2) no limitations to the types of graphics tablet (digitizer) can be used;

(3) it is unnecessary for the user to change battery; and

(4) low manufacturing cost.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A touch stylus, comprising:
a piezoelectric unit, formed by a piezoelectric material;
a magnet unit, coupled to the piezoelectric unit; and
a coil unit, evenly wound on the magnet unit;
wherein when a tip of the touch stylus is forced and generates a vibration, the piezoelectric material of the piezoelectric unit is deformed by force to generate a piezoelectric current; when the touch stylus is shaken, a distance between the coil unit and the magnet unit is changed due to a relative movement between the coil unit and the magnet unit and the coil unit generates an induced current due to a change of magnetic flux.

2. The touch stylus of claim 1, further comprising:
an energy storage unit, coupled to the piezoelectric unit and the coil unit, for storing the extra piezoelectric current and induced current as reserve power.

3. The touch stylus of claim 1, further comprising:
a bonding substrate, disposed between the tip of the touch stylus and the piezoelectric unit, for passing a pressure that the tip of the touch stylus is pressed to the piezoelectric unit.

4. The touch stylus of claim 1, further comprising:
a spring unit, coupled to the magnet unit, for providing an elastic force and a buffering effect.

5. The touch stylus of claim 2, wherein the energy storage unit is an energy storage element.

6. A method of operating a touch stylus, the touch stylus comprising a piezoelectric unit, a magnet unit, and a coil unit, the piezoelectric unit being formed by a piezoelectric material, the magnet unit being coupled to the piezoelectric unit, the coil unit being evenly wound on the magnet unit, the method comprising steps of:
(a) when a tip of the touch stylus is forced and generates a vibration, the piezoelectric material of the piezoelectric unit being deformed by force to generate a piezoelectric current; and
(b) when the touch stylus is shaken, a distance between the coil unit and the magnet unit being changed due to a relative movement between the coil unit and the magnet unit and the coil unit generating an induced current due to a change of magnetic flux.

7. The method of claim 6, wherein the touch stylus further comprises an energy storage unit coupled to the piezoelectric unit and the coil unit, the method further comprises a step of:
storing the extra piezoelectric current and induced current as reserve power via the energy storage unit.

8. The method of claim 6, wherein the touch stylus further comprises a bonding substrate disposed between the tip of the touch stylus and the piezoelectric unit, the method further comprises a step of:
passing a pressure that the tip of the touch stylus is pressed to the piezoelectric unit.

9. The method of claim 6, wherein the touch stylus further comprises a spring unit coupled to the magnet unit, the method further comprises a step of:
providing an elastic force and a buffering effect via the spring unit.

10. The method of claim 7, wherein the energy storage unit is an energy storage element.
